(19) United States
(12) Patent Application Publication
(10) Pub. No.: US 2025/0293981 A1
(43) Pub. Date: Sep. 18, 2025

(54) METHOD FOR REBALANCING TRAFFIC AND SYSTEM THEREFOR

(71) Applicant: SAMSUNG SDS CO., LTD., Seoul (KR)

(72) Inventors: Young Woon KWUN, Seoul (KR); Hwa Yong OH, Seoul (KR); Jung Ho LEE, Seoul (KR); Kwang Cheol LEE, Seoul (KR)

(73) Assignee: SAMSUNG SDS CO., LTD., Seoul (KR)

(21) Appl. No.: 19/079,991

(22) Filed: Mar. 14, 2025

(30) Foreign Application Priority Data
Mar. 14, 2024 (KR) 10-2024-0035807

(51) Int. Cl. H04L 47/125; H04L 45/74

(52) U.S. Cl. CPC H04L 47/125; H04L 45/74

(57) ABSTRACT

A traffic distribution method may include acquiring traffic data on a quantity of inbound traffic to each of a plurality of servers; calculating a coefficient of variation of the traffic data for a first unit time duration, an interval average of coefficients of variation for a second unit time duration, and an interval standard deviation of the coefficients of variation for the second unit time duration, wherein the second unit time duration includes a plurality of first unit time durations; performing a real-time calculation on the coefficient of variation of the traffic data for the first unit time duration to calculate a real-time coefficient of variation; determining whether a traffic distribution imbalance state across the plurality of servers occurs, based on comparing the real-time coefficient of variation with the interval average and the interval standard deviation; and performing traffic distribution across the plurality of servers, based on the determination.

### CROSS-REFERENCE TO RELATED APPLICATION

This application claims priority from Korean Patent Application No. 10-2024-0035807 filed on Mar. 14, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a traffic distribution method and system. More specifically, the present disclosure relates to a traffic distribution method and system for rebalancing traffic.

### Description of Related Art

Traffic rebalancing refers to a process that evenly distributes traffic generated in a network or system, and may distribute a load generated from network equipment or servers in a balanced manner to optimize performance of the entire system.

The traffic rebalancing is implemented using a load balancer or software. Such a load balancer and software play a role in distributing the load by analyzing an incoming request and transmitting the request to an appropriate server. Thus, the stability and performance of the entire system may be improved.

### PRIOR ART LITERATURE

Patent document: Korean Patent Application Publication No. 10-2017-0094796 (2017 Aug. 21 Publication)

### SUMMARY

A technical purpose to be achieved in some embodiments of the present disclosure is to provide a traffic distribution method and system for sensing a traffic distribution imbalance state.

Another technical purpose to be achieved in some embodiments of the present disclosure is to provide a traffic distribution method and system for detecting a traffic distribution imbalance state and performing traffic distribution across a plurality of servers based on the detecting result.

Still another technical purpose to be achieved in some embodiments of the present disclosure is to provide a traffic distribution method and system in which an environment in which a system for performing a complex computation for detecting a traffic distribution imbalance state and a system for performing traffic distribution are separated from each other such that a limited resource in each environment is efficiently used.

The technical purposes of the present disclosure are not limited to the technical purposes mentioned above, and other technical purposes not mentioned may be clearly understood by those skilled in the art from the following description.

According to an aspect of the present disclosure, there is provided a traffic distribution method for load-balancing inbound traffic incoming into a plurality of servers, the traffic distribution method being performed by a computing system. The traffic distribution method may comprise: acquiring traffic data on a quantity of inbound traffic to each of the plurality of servers; calculating a coefficient of variation of the traffic data for a first unit time duration, an interval average of coefficients of variation for a second unit time duration, and an interval standard deviation of the coefficients of variation for the second unit time duration, wherein the second unit time duration includes a plurality of first unit time durations; performing a real-time calculation on the coefficient of variation of the traffic data for the first unit time duration to calculate a real-time coefficient of variation; determining whether a traffic distribution imbalance state across the plurality of servers occurs, based on a result of comparing the real-time coefficient of variation with the interval average and the interval standard deviation; and performing traffic distribution across the plurality of servers, based on the determination result of whether the traffic distribution imbalance state across the plurality of servers occurs.

In accordance with one embodiment of the traffic distribution method, the coefficient of variation for the first unit time duration may be a value obtained by dividing a standard deviation of the inbound traffic incoming into the plurality of servers for the first unit time duration by an average of the inbound traffic incoming into the plurality of servers for the first unit time duration.

In accordance with one embodiment of the traffic distribution method, the determining of whether the traffic distribution imbalance state across the plurality of servers occurs may include: calculating a first threshold based on a following Equation 1; and determining whether the real-time coefficient of variation exceeds the first threshold:

First threshold=(the interval average)+{n*(the interval standard deviation)}, where n is a non-negative integer. [Equation 1]

In accordance with one embodiment of the traffic distribution method, the determining of whether the real-time coefficient of variation exceeds the first threshold may include: acquiring first data on a quantity of traffic processed by the computing system for the first unit time duration; determining whether the first data exceeds a second threshold; and only upon determination that the first data exceeds the second threshold, determining whether the real-time coefficient of variation exceeds the first threshold, wherein the second threshold is a value of a minimum quantity of traffic for performing traffic distribution across the plurality of servers.

In accordance with one embodiment of the traffic distribution method, the determining of whether the real-time coefficient of variation exceeds the first threshold may include: upon determination that the real-time coefficient of variation exceeds the first threshold, determining whether the traffic distribution across the plurality of servers has been achieved at a target level; upon determination that the traffic distribution has been achieved at the target level, initializing a server-specific weight of each of the plurality of servers; and upon determination that the traffic distribution has not been achieved at the target level, updating the server-specific weight of each of the plurality of servers.

In accordance with one embodiment of the traffic distribution method, the determining of whether the traffic distribution across the plurality of servers has been achieved at the target level may include: comparing a first real-time coefficient of variation at a first time point with a second real-time coefficient of variation at a second time point; and determining whether the traffic distribution has been achieved at the target level, based on a result of the comparison, wherein the first time point may precede the second time point by the first unit time duration.

In accordance with one embodiment of the traffic distribution method, the updating of the server-specific weight may include: calculating an average of quantities of the inbound traffic for the first unit time duration of a first server and a second server constituting the plurality of servers, wherein the quantity of the inbound traffic for the first unit time duration of the first server is greater than the quantity of the inbound traffic for the first unit time duration of the second server; calculating a weight of the first server and a weight of the second server using the quantity of the inbound traffic for the first unit time duration of the first server as a reference value; and updating the average, the weight of the first server, and the weight of the second server in a server weight table.

In accordance with one embodiment of the traffic distribution method, the performing of the traffic distribution across the plurality of servers may include: determining a third server to which first inbound traffic received by the computing system is to be transmitted, using a predetermined path selection algorithm; and determining whether to perform traffic distribution to the third server, with reference to a server weight table, wherein the server weight table may include information about a server-specific weight of each of the plurality of servers and an average of quantities of the inbound traffic for the first unit time duration of the plurality of servers.

In accordance with one embodiment of the traffic distribution method, the traffic distribution method may further comprise: determining whether the first inbound traffic is a new connection with reference to connection information of the first inbound traffic; and upon determination the first inbound traffic is not the new connection, transmitting the first inbound traffic to a fourth server that has received traffic related to the first inbound traffic, using destination information included in the connection information of the first inbound traffic; or upon determination that the first inbound traffic is the new connection, determining the third server and determining whether to perform traffic distribution to the third server.

In accordance with one embodiment of the traffic distribution method, the determining of whether to perform the traffic distribution to the third server may include: in response to that the determined third server receives a quantity of the inbound traffic exceeding the average, performing traffic distribution to a fifth server having a highest weight based on a server-specific weight of each of the plurality of servers.

In accordance with one embodiment of the traffic distribution method, the determining of whether to perform the traffic distribution to the third server may include: in response to that the determined third server receives a quantity of the inbound traffic smaller than or equal to the average, transmitting the first inbound traffic to the third server.

In accordance with one embodiment of the traffic distribution method, the determining of whether to perform the traffic distribution to the third server may include storing information about a server to which the first inbound traffic is to be transmitted in the connection information of the first inbound traffic, wherein the information about the server may include a result of performing the determining of whether to perform the traffic distribution to the third server.

In accordance with one embodiment of the traffic distribution method, the computing system may comprise a managing system operating in a first environment and a load balancer operating in a second environment, wherein the acquiring of the traffic data, the calculating of the coefficient of variation of the traffic data for the first unit time duration, the interval average of the coefficients of variation for the second unit time duration, and the interval standard deviation of the coefficients of variation for the second unit time duration, the calculating of the real-time coefficient of variation, and the determining of whether the traffic distribution imbalance state across the plurality of servers occurs may be performed by the managing system, and the performing of the traffic distribution across the plurality of servers may be performed by the load balancer, wherein the first environment may be isolated from the second environment.

According to another aspect of the present disclosure, there is provided a traffic distribution computing system for load-balancing inbound traffic across a plurality of servers. The traffic distribution computing system may include a communication interface; a memory into which a computer program is loaded; and one or more processors configured to execute the computer program, wherein the computer program may include instructions for: acquiring traffic data on a quantity of inbound traffic to each of the plurality of servers; calculating a coefficient of variation of the traffic data for a first unit time duration, an interval average of coefficients of variation for a second unit time duration, and an interval standard deviation of the coefficients of variation for the second unit time duration, wherein the second unit time duration may include a plurality of first unit time durations; performing a real-time calculation in on the coefficient of variation of the traffic data for the first unit time duration to calculate a real-time coefficient of variation; determining whether a traffic distribution imbalance state across the plurality of servers occurs, based on a result of comparing the real-time coefficient of variation with the interval average and the interval standard deviation; and performing traffic distribution across the plurality of servers, based on the determination result of whether the traffic distribution imbalance state across the plurality of servers occurs.

In accordance with one embodiment of the traffic distribution computing system, the determining of whether the traffic distribution imbalance state across the plurality of servers occurs may include: calculating a first threshold based on the above Equation 1; and determining whether the real-time coefficient of variation exceeds the first threshold:

In accordance with one embodiment of the traffic distribution computing system, the determining of whether the real-time coefficient of variation exceeds the first threshold may include: acquiring first data on a quantity of traffic processed by the computing system for the first unit time duration; determining whether the first data exceeds a second threshold; and only upon determination that the first data exceeds the second threshold, determining whether the real-time coefficient of variation exceeds the first threshold, wherein the second threshold may be a value of a minimum quantity of traffic for performing traffic distribution across the plurality of servers.

In accordance with one embodiment of the traffic distribution computing system, the determining of whether the real-time coefficient of variation exceeds the first threshold may include: upon determination that the real-time coefficient of variation exceeds the first threshold, determining whether the traffic distribution across the plurality of servers has been achieved at a target level; upon determination that the traffic distribution has been achieved at the target level, initializing a server-specific weight of each of the plurality of servers; and upon determination that the traffic distribution has not been achieved at the target level, updating the server-specific weight of each of the plurality of servers.

In accordance with one embodiment of the traffic distribution computing system, the determining of whether the traffic distribution across the plurality of servers has been achieved at the target level may include: comparing a first real-time coefficient of variation at a first time point with a second real-time coefficient of variation at a second time point; and determining whether the traffic distribution has been achieved at the target level, based on a result of the comparison, wherein the first time point precedes the second time point by the first unit time duration.

In accordance with one embodiment of the traffic distribution computing system, the updating of the server-specific weight may include: calculating an average of quantities of the inbound traffic for the first unit time duration of a first server and a second server constituting the plurality of servers, wherein the quantity of the inbound traffic for the first unit time duration of the first server is greater than the quantity of the inbound traffic for the first unit time duration of the second server; calculating a weight of the first server and a weight of the second server using the quantity of the inbound traffic for the first unit time duration of the first server as a reference value; and updating the average, the weight of the first server, and the weight of the second server in a server weight table.

In accordance with one embodiment of the traffic distribution computing system, the performing of the traffic distribution across the plurality of servers may include: determining a third server to which first inbound traffic received by the computing system is to be transmitted, using a predetermined path selection algorithm; and determining whether to perform traffic distribution to the third server, with reference to a server weight table, wherein the server weight table may include information about a server-specific weight of each of the plurality of servers and an average of quantities of the inbound traffic for the first unit time duration of the plurality of servers.

In accordance with one embodiment of the traffic distribution computing system, the computer program may further include instructions for: determining whether the first inbound traffic is a new connection with reference to connection information of the first inbound traffic; and upon determination the first inbound traffic is not the new connection, transmitting the first inbound traffic to a fourth server that has received traffic related to the first inbound traffic, using destination information included in the connection information of the first inbound traffic; or upon determination that the first inbound traffic is the new connection, determining the third server and determining whether to perform traffic distribution to the third server.

In accordance with one embodiment of the traffic distribution computing system, the determining of whether to perform the traffic distribution to the third server may include: in response to that the determined third server receives a quantity of the inbound traffic exceeding the average, performing traffic distribution to a fifth server having a highest weight based on a server-specific weight of each of the plurality of servers.

In accordance with one embodiment of the traffic distribution computing system, the determining of whether to perform the traffic distribution to the third server may include: in response to that the determined third server receives a quantity of the inbound traffic smaller than or equal to the average, transmitting the first inbound traffic to the third server.

In accordance with one embodiment of the traffic distribution computing system, the determining of whether to perform the traffic distribution to the third server may include: storing information about a server to which the first inbound traffic is to be transmitted in the connection information of the first inbound traffic, wherein the information about the server may include a result of performing the determining of whether to perform the traffic distribution to the third server.

In accordance with one embodiment of the traffic distribution computing system, the computing system may comprise a managing system operating in a first environment and a load balancer operating in a second environment, wherein the acquiring of the traffic data, the calculating of the coefficient of variation of the traffic data for the first unit time duration, the interval average of coefficients of variation for the second unit time duration, and the interval standard deviation of the coefficients of variation for the second unit time duration, the calculating of the real-time coefficient of variation, and the determining of whether the traffic distribution imbalance state across the plurality of servers occurs may be performed by the managing system, and the performing of the traffic distribution across the plurality of servers may be performed by the load balancer, wherein the first environment may be isolated from the second environment.

According to another aspect of the present disclosure, there is provided a non-transitory computer-readable recording medium storing computer program coupled to a computing device for load-balancing inbound traffic incoming into a plurality of servers. The computer program may execute acquiring traffic data on a quantity of inbound traffic to each of the plurality of servers; calculating a coefficient of variation of the traffic data for a first unit time duration, an interval average of coefficients of variation for a second unit time duration, and an interval standard deviation of the coefficients of variation for the second unit time duration, wherein the second unit time duration may include a plurality of first unit time durations; performing a real-time calculation on the coefficient of variation of the traffic data for the first unit time duration to calculate a real-time coefficient of variation; determining whether a traffic distribution imbalance state across the plurality of servers occurs, based on a result of comparing the real-time coefficient of variation with the interval average and the interval standard deviation; and performing traffic distribution across the plurality of servers, based on the determination result of whether the traffic distribution imbalance state across the plurality of servers occurs.

### BRIEF DESCRIPTION OF DRAWINGS

The above and other aspects and features of the present disclosure will become more apparent by describing in detail embodiments thereof with reference to the attached drawings, in which:

FIG. 1 is an example diagram for illustrating a problem of a conventional traffic distribution method;

FIG. 2 is a configuration diagram of a traffic distribution system according to an embodiment of the present disclosure;

FIG. 3 is a flowchart illustrating a traffic distribution method according to another embodiment of the present disclosure;

FIG. 4 is a detailed flowchart for illustrating some operations of the traffic distribution method as described with reference to FIG. 3;

FIGS. 5 and 6 are detailed flowcharts for illustrating some operations of the traffic distribution method as described with reference to FIG. 4;

FIGS. 7 and 8 are detailed flowcharts for illustrating some operations of the traffic distribution method as described with reference to FIG. 6;

FIG. 9 is a diagram for illustrating a process of determining whether a traffic distribution imbalance state is present, which may be performed in some embodiments of the present disclosure;

FIG. 10 is a detailed flowchart for illustrating some operations of the traffic distribution method as described with reference to FIG. 3;

FIG. 11 is a diagram for illustrating a process of performing traffic distribution across a plurality of servers, which may be performed in some embodiments of the present disclosure;

FIGS. 12A and 12B are diagrams illustrating a performance result performed by some embodiments of the present disclosure; and

FIG. 13 is a hardware configuration diagram of a computing system according to some embodiments of the present disclosure.

### DETAILED DESCRIPTION

Hereinafter, preferred embodiments of the present disclosure will be described in detail with reference to the accompanying drawings. Advantages and features of the present disclosure and methods of achieving them will be apparent with reference to embodiments described in detail below together with the accompanying drawings. However, the technical idea of the present disclosure is not limited to the following embodiments, but may be implemented in various different forms, and the following embodiments are provided to complete the technical idea of the present disclosure and to fully inform those skilled in the art to which the present disclosure pertains of the scope of the present disclosure, and the technical idea of the present disclosure is only defined by the scope of the claims.

In the description of the present disclosure, when it is determined that a detailed description of related known components or functions may obscure the gist of the present disclosure, the detailed description thereof will be omitted.

Unless otherwise defined, the terms (including technical and scientific terms) used in the following embodiments may be used in a manner such that the terms may be commonly understood by those skilled in the art to which the present disclosure belongs. However, the meaning thereof may vary depending on the intention of a person skilled in the related art, or precedents, and the emergence of a new technology, and the like. The terminology used in the present disclosure is intended to describe the embodiments and is not intended to limit the scope of the present disclosure.

The singular expression of a component as used in the following embodiments includes the concept of “plural” thereof, unless the context clearly specifies that the component is singular. In addition, the plural expression of the component include the concept of “singular” thereof unless the context clearly specifies that the component is plural.

In addition, terms such as first, second, A, B, (a), (b), and the like used in the following embodiments are used to distinguish a certain component from another component, and the nature, sequence, or order of a component modified by the term is not limited by the term.

Hereinafter, various embodiments of the disclosure will be as described with reference to the accompanying drawings.

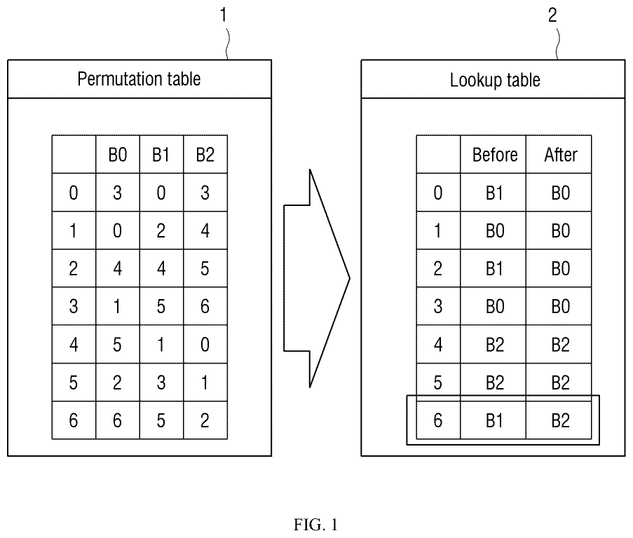

Hereinafter, a problem of a conventional traffic distribution method will be as described with reference to FIG. 1.

FIG. 1 is an example diagram for illustrating a problem of the conventional traffic distribution method.

Referring to FIG. 1, an operation of a Maglev hashing algorithm as an algorithm of a network load balancer devised by Google is illustrated. When performing the load balancing, the Maglev hashing algorithm enables the traffic to be uniformly distributed across the servers, minimizes a connection-broken phenomenon on a related request when there is a change in the number of servers due to addition or deletion of the server, and simultaneously prevents the traffic from being concentrated on a specific server.

The Maglev hashing algorithm first generates a fixed number of virtual servers for each server. The virtual servers are B0, B1 and B2 shown in a permutation table 1. This virtual server is responsible for hash mapping for all possible servers. Then, when a client request is received, a hash value of the request is calculated and a virtual server that matches the hash value is selected. Thus, the request is routed to a specific server, and the load may be evenly distributed between the servers.

The key idea of the Maglev hashing algorithm is to perform server selection using the permutation table 1. This permutation table 1 is used to select each virtual server in a round-robin manner. A collision may occur in the process of selecting the virtual server. However, in order to solve this problem, the permutation table 1 may be adjusted so that the collision is minimized at the next selection.

Since the Maglev hashing algorithm generates a constant hash value for each request, the same request is always routed to the same server. Therefore, when the load balancing is performed, a connection-broken phenomenon may be prevented. In addition, the Maglev hashing algorithm may efficiently operate even when a server is added or removed, thereby providing system flexibility. For example, referring to a lookup table 2, when the virtual server B1 shown in the permutation table 1 is removed, processes distributed to the B1 are uniformly distributed to the B0 and the B2, respectively, so that efficient load balancing may be performed.

However, the Maglev hashing algorithm does not suggest a scheme for performing traffic distribution across all servers when the traffic is concentrated on a specific server at runtime. Accordingly, a traffic distribution method according to the present disclosure proposes an efficient load balancing method by performing traffic distribution on traffic or a request transmitted to each of the servers at runtime.

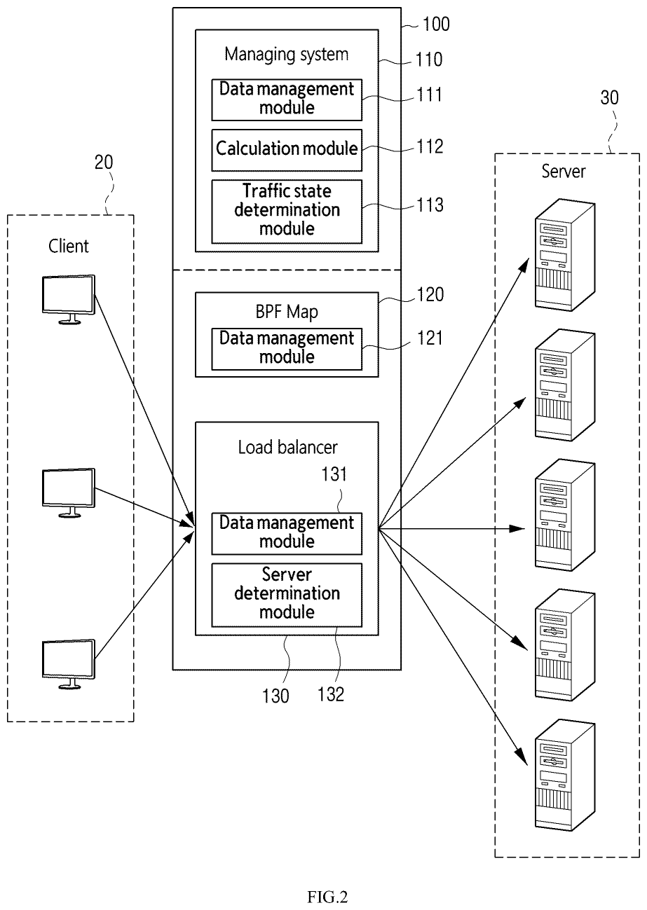

Hereinafter, a configuration and an operation of a traffic distribution system according to an embodiment of the present disclosure will be as described with reference to FIG. 2. FIG. 2 is a configuration diagram of a traffic distribution system according to an embodiment of the present disclosure.

Referring to FIG. 2, a traffic distribution system 100 may be configured to include a managing system 110, an BPF map 121, and a load balancer 130. However, the scope of the present disclosure is not limited thereto. In some cases, the traffic distribution system 100 may be configured to further include a module/device/system not shown in FIG. 2. Alternatively, the traffic distribution system 100 may be configured in a structure in which at least some of the components 10 to 30 as illustrated in FIG. 2 are excluded.

The managing system 110 may include a data management module 111, a calculation module 112, and a traffic state determination module 113. The managing system 110 may obtain traffic data on a quantity of inbound traffic received from a client 20. The managing system 110 may calculate a real-time coefficient of variation of the quantity of the inbound traffic, an interval average thereof, and an interval standard deviation thereof. The managing system 110 may compare the real-time coefficient of variation with a specific threshold including the interval average and the interval standard deviation and determine whether a plurality of servers 30 are in a traffic distribution imbalance state, based on the comparing result. The managing system 110 may transmit information including whether the traffic distribution imbalance state is present to the BPF map 120.

The BPF (Berkeley Packet Filter) map 120 refers to a technology required to provide a virtual machine environment for a program executed in a kernel region. In the traffic distribution system 100, the BPF map 120 may serve to store data transferred by the managing system 110 and the load balancer 130 in a memory region, and may act as an interface that enables communication between the managing system 110 and the load balancer 130. The BPF map 120 may be configured to include a data management module 121.

The load balancer 130 may include a data management module 131 and a server determination module 132. The load balancer 130 may receive the inbound traffic incoming from the client 20 to the plurality of servers 30. The load balancer 130 may receive information including whether the traffic distribution imbalance state is present as determined by the managing system 110 from the BPF map 120. The load balancer 130 may perform the traffic distribution of the inbound traffic using the information to determine a server to which the inbound traffic is to be transmitted. Via the above operation, the load balancer 130 may uniformly distribute the traffic across the plurality of servers 30.

In the traffic distribution system 100, the managing system 110 may operate in a first environment, while the BPF map 120 and the load balancer 130 may operate in a second environment. The first environment may be isolated from the second environment. For example, the first environment may be a user space in which an application operates, and the second environment may be a kernel space in which various modules/devices/systems of an operating system operate. That is, the first environment may be an environment in which an available resource is sufficient, whereas the second environment may be an environment in which an available resource is insufficient relative to the first environment. The load balancer 130 operating in the second environment is not affected by a resource usage in the first environment.

Since the load balancer 130 is an extended Berkeley Packet Filter (eBBF) program operating in the kernel space, the load balancer 130 cannot process a complex mathematical formula or a calculation requiring a large quantity of computing resources. Accordingly, the managing system 110 may calculate the real-time coefficient of variation that involves a significant amount of calculation, the interval average thereof, and the interval standard deviation thereof, determine whether the traffic distribution imbalance state is present, based on the calculation result, and transmit the determination result to the load balancer 130. Thereafter, the load balancer 130 may perform only the traffic distribution based on the determination result. Since the roles of the managing system 110 and the load balancer 130 are separated from each other, the load balancing may be performed at runtime while efficiently using the resource according to the characteristics of the environment to which each system belongs.

Hereinafter, in order to provide convenience of understanding, it is assumed that all steps/operations of the methods to be described below are performed in the traffic distribution system 100 as described above. Accordingly, when a subject of a specific step/operation is omitted, it may be understood that the traffic distribution system 100 performs the specific step/operation. However, in an actual environment, some steps/operations of the method to be described later may be performed in another computing device.

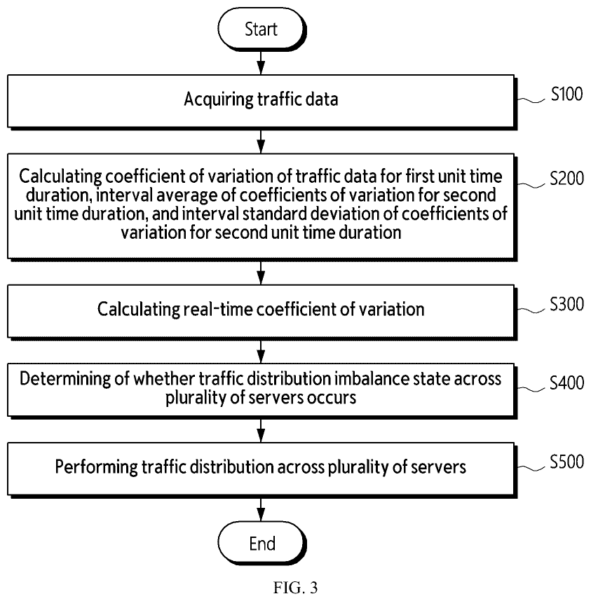

Hereinafter, a traffic distribution method according to an embodiment of the present disclosure will be as described with reference to FIG. 3. FIG. 3 is a flowchart illustrating a traffic distribution method according to an embodiment of the present disclosure.

Referring to FIG. 3, the data management module 111 mounted in the managing system 110 may acquire traffic data on a quantity of the inbound traffic to each of the plurality of servers 30 in S100. The load balancer 130 may receive the inbound traffic to each of the servers from the client 20, and the data management module 131 mounted in the load balancer 130 may transmit the received the inbound traffic to each of the servers to the BPF map 120. The data management module 121 mounted in the BPF map 120 may store the received information on the inbound traffic to each of the servers. The data management module 111 may receive information about the inbound traffic to each of the servers from the BPF map 120 to obtain traffic data about the quantity of the inbound traffic to each of the plurality of servers 30.

Thereafter, the calculation module 112 mounted in the managing system 110 may calculate a coefficient of variation for a first unit time duration, an interval average for a second unit time duration of the coefficients of variation, and an interval standard deviation thereof using the acquired traffic data in S200. In this case, the second unit time duration may include a plurality of first unit time durations. For example, the first unit time duration may be 1 second, and the second unit time duration may be 60 seconds including the first unit time durations. That is, the calculation module 112 may calculate the coefficient of variation every 1 second, and may collecting the coefficient of variation calculated every 1 second and calculate the interval average and the interval standard deviation of the coefficient of variation on a 60 seconds basis

In the above step, the coefficient of variation for the first unit time duration may be a value obtained by dividing a standard deviation of the inbound traffic entering the plurality of servers 30 for the first unit time duration by an average of the inbound traffic entering the plurality of servers 30 for the first unit time duration. That is, the coefficient of variation for the first unit time duration may be used as a measure for determining whether the inbound traffic is concentrated on a specific server among the plurality of servers 30.

Thereafter, the calculation module 112 may calculate the real-time coefficient of variation by performing a real-time calculation on the coefficient of variation of the traffic data for the first unit time duration in S300. The real-time coefficient of variation may be calculated in the same manner as a manner in which the coefficient of variation for the first unit time duration as mentioned above is calculated. A decrease in the real-time coefficient of variation means that the request of the client 20 is uniformly distributed across the servers 30, whereas an increase in the real-time coefficient of variation means that the request of the client 20 is concentrated on a specific server.

Thereafter, the traffic state determination module 113 mounted in the managing system 110 may determine whether the traffic distribution imbalance state across the plurality of servers 30 is present based on the result of comparing the real-time coefficient of variation with the interval average and the interval standard deviation for the second unit time duration of the coefficient of variation in S400. The traffic distribution imbalance state may mean state information about whether the request of the client 20 is uniformly distributed across the servers 30 or the request of the client 20 is concentrated on a specific server. A method for determining whether the traffic distribution imbalance state occurs will be described in detail later.

Thereafter, the server determination module 132 mounted in the load balancer 130 may perform traffic distribution across the plurality of servers 30, based on whether the traffic distribution imbalance state across the plurality of servers 30 occurs in S500. The server determination module 132 may determine whether distribution of traffic is necessary based on the calculation result of the managing system 110 and the traffic distribution imbalance state determination result, determine a server to which the inbound traffic is to be transmitted based on the determination result, and transmit the inbound traffic to the determined server. A method for performing the traffic distribution across the plurality of servers 30 will be described in detail later.

According to the present embodiment, the traffic distribution system 100 may determine whether the traffic is uniformly distributed across the plurality of servers 30 even at runtime, and efficiently rebalance the traffic even during the runtime based on the determination result.

In an embodiment, the traffic distribution system 100 may include the managing system 110 operating in a first environment and the load balancer 130 operating in a second environment. The first environment may be isolated from the second environment. For example, the first environment may be a user space in which an application operates, and the second environment may be a kernel space in which various modules/devices/systems of an operating system operate. That is, the first environment may be an environment in which there are sufficient available resources, while the second environment may be an environment in which there are insufficient available resources relative to the first environment. The load balancer 130 operating in the second environment is not affected by the resource usage in the first environment.

In this case, in the traffic distribution method according to an embodiment of the disclosure as described with reference to FIG. 3, operations S100 to S400 may be performed by the managing system 110, and operation S500 may be performed by the load balancer 130. Since the load balancer 130 is an extended Berkeley Packet Filter (eBBF) program operating in the kernel space, the load balancer 130 cannot process a complex mathematical formula or computation requiring a large quantity of computing resources. Accordingly, the managing system 110 may calculate the real-time coefficient of variation that involves a significant amount of calculation, and the interval average thereof, and the interval standard deviation thereof, determine whether a traffic distribution imbalance state occurs based on the calculation result, and transmit the determination result to the load balancer 130. Thereafter, the load balancer 130 may perform only traffic distribution based on the determination result.

Therefore, according to the present embodiment, since the roles of the managing system 110 and the load balancer 130 are separated from each other, the resources are efficiently used based on the characteristics of the environment to which each system belongs, while load balancing is achieved at runtime.

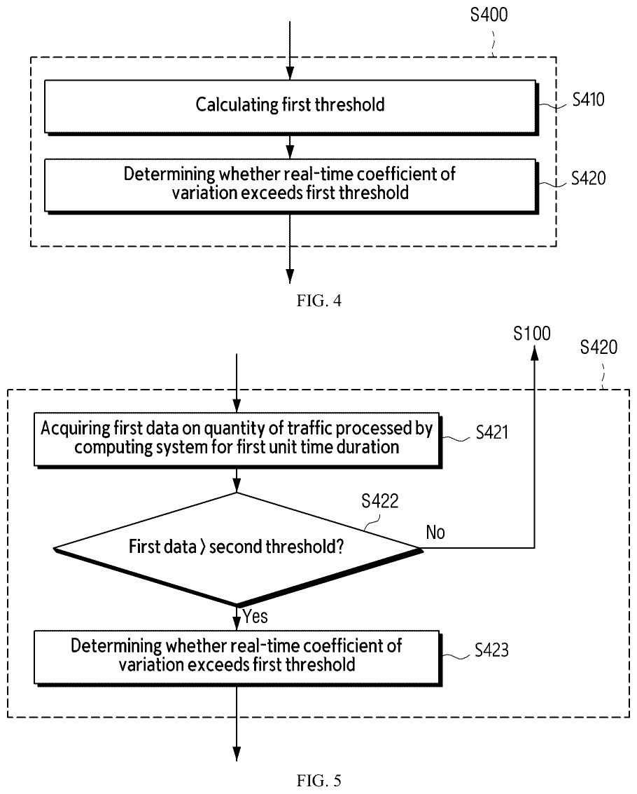

Hereinafter, a method for determining whether the traffic distribution imbalance state occurs according to some embodiments of the present disclosure will be as described with reference to FIGS. 4 to 9.

First, a method for comparing a real-time coefficient of variation with an interval average and an interval standard deviation for a second unit time duration of coefficient of variations according to an embodiment of the present disclosure will be as described with reference to FIG. 4. FIG. 4 is a detailed flowchart for illustrating some operations of the traffic distribution method as described with reference to FIG. 3.

Referring to FIG. 4, the traffic state determination module 113 may calculate a first threshold value according to Equation 1 as set forth below in S410.

First threshold=(interval average for second unit time duration of coefficient of variations)+{n*(interval standard deviation for second unit time duration of coefficient of variations)} [Equation 1]

In this regard, in the Equation 1, n may be an integer other than a negative integer. n may be set to vary according to a type of services provided from the plurality of servers 30. As n is smaller, traffic distribution of the inbound traffic across the plurality of servers 30 occurs frequently, thereby reducing the real-time coefficient of variation, while there may be a problem in that a connection-broken phenomenon of a related request occurs frequently. For example, when n is 1, traffic distribution of the inbound traffic across the plurality of servers 30 occurs frequently relative to that when n is 2, thereby reducing the real-time coefficient of variation, while the connection-broken phenomenon of the related request may occur frequently. Accordingly, n may be set to vary depending on whether the service provided from the plurality of servers 30 is a service in which the traffic distribution should be uniformly performed across the plurality of servers 30 or a service in which the connection-broken phenomenon of the related request should be suppressed.

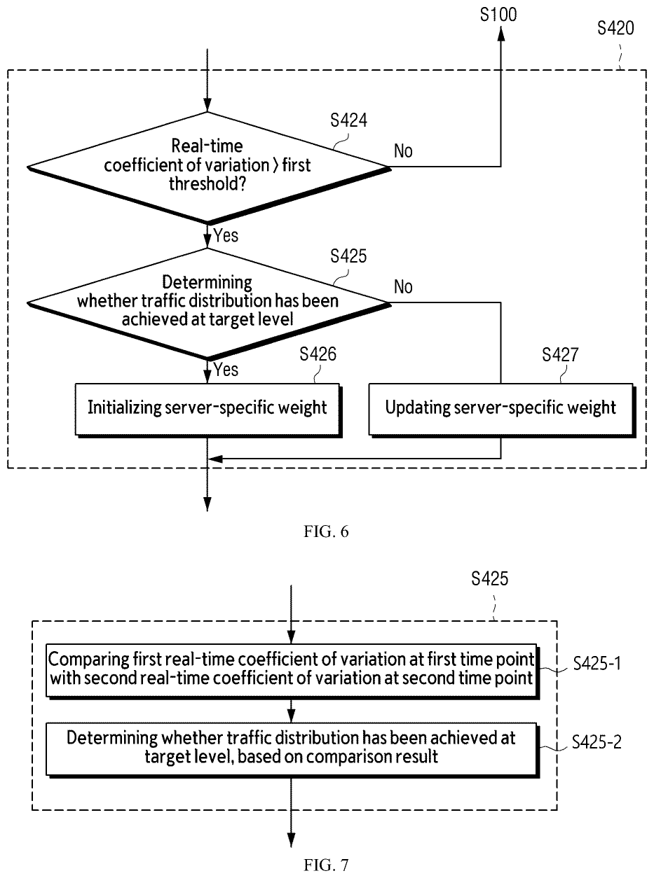

Thereafter, the traffic state determination module 113 may determine whether the real-time coefficient of variation exceeds the first threshold calculated in the above operation in S420. Hereinafter, a method for determining whether the real-time coefficient of variation exceeds the first threshold according to some embodiments of the present disclosure will be as described with reference to FIGS. 5 and 6. FIGS. 5 and 6 are detailed flowcharts for illustrating some operations of the traffic distribution method as described with reference to FIG. 4.

First, the present disclosure will be as described with reference to FIG. 5.

Referring to FIG. 5, the traffic state determination module 113 may obtain first data on a quantity of traffic processed by the traffic distribution system 100 during a first unit time duration in S421. A unit of the first data may be a request per second (RPS), and the first unit time duration may be set to 1 second.

Thereafter, the traffic state determination module 113 may determine whether the first data exceeds a second threshold in S422. The second threshold may be a value of a quantity of minimum traffic for performing traffic distribution across the plurality of servers 30. In this regard, the second threshold may be set to vary based on the types of resources allocated to the load balancer 130 and the plurality of servers 30 and types of the services provided from the plurality of servers 30.

When the first data on the quantity of traffic processed for the first unit time duration is smaller than the second threshold as a value of the minimum quantity of traffic for performing traffic distribution across the plurality of servers 30, this means that there are not many requests from the client 20 such that the traffic distribution system 100 does not perform the traffic distribution. Accordingly, in this case, since the load balancer 130 and the plurality of servers 30 may sufficiently deal with the request of the client 20, the traffic state determination module 113 determines whether the traffic distribution imbalance state across the plurality of servers 30 occurs only when the first data exceeds the second threshold.

When the first data exceeds the second threshold, the traffic state determination module 113 may perform a step of determining whether the real-time coefficient of variation exceeds the first threshold in S423. That is, only when the first data exceeds the second threshold, the traffic state determination module 113 determines whether the traffic distribution imbalance state across the plurality of servers 30 occurs.

On the contrary, when the first data is smaller than or equal to the second threshold, the managing system 110 may perform the process from the operation S100 again to continuously monitor whether the traffic distribution imbalance state across the plurality of servers 30 occurs.

Next, the present disclosure will be described with reference to FIG. 6.

In an embodiment, the traffic state determination module 113 may determine whether the real-time coefficient of variation exceeds the first threshold in S424.

When the real-time coefficient of variation is smaller than or equal to the first threshold, the managing system 110 may perform the process from the operation S100 again to continuously monitor whether the traffic distribution imbalance state across the plurality of servers 30 occurs. Since the fact that the real-time coefficient of variation is smaller than first threshold means that the request of the client 20 is uniformly distributed across the plurality of servers 30, there is no need to perform traffic distribution (rebalancing) on the inbound traffic. Accordingly, the managing system 110 may perform the process from the operation S100 again to continuously monitor whether the traffic distribution imbalance state across the plurality of servers 30 occurs.

On the contrary, when the real-time coefficient of variation exceeds the first threshold, the traffic state determination module 113 may determine whether the traffic distribution between the plurality of servers 30 has been achieved at a target level in S425. Hereinafter, a method for determining whether the traffic distribution has been achieved at the target level according to an embodiment of the present disclosure will be as described with reference to FIG. 7. FIG. 7 is a detailed flowchart for illustrating some operations of the traffic distribution method as described with reference to FIG. 6.

Referring to FIG. 7, the traffic state determination module 113 may compare a first real-time coefficient of variation at a first time point with a second real-time coefficient of variation at a second time point in S425-1. In this regard, the first time point may be a time point preceding the second time point by the first unit time duration.

The traffic state determination module 113 may store the first real-time coefficient of variation when the real-time coefficient of variation exceeds the first threshold at the first time point, that is, when traffic is concentrated on a specific server among the plurality of servers 30. The traffic state determination module 113 may calculate the second real-time coefficient of variation and may compare whether the second real-time coefficient of variation is improved relative to the first real-time coefficient of variation. In this case, a real-time coefficient of variation improvement percentage as an improvement percentage by which the second real-time coefficient of variation is improved relative to the first real-time coefficient of variation may be set to 5%. However, embodiments of the present disclosure are not limited thereto, and the real-time coefficient of variation improvement percentage may be set to vary based on the types of the services provided from the plurality of servers 30.

That is, the traffic state determination module 113 may calculate the real-time coefficient of variation improvement percentage based on a comparing result between the first real-time coefficient of variation and the second real-time coefficient of variation having the time point difference equal to the first unit time duration. When the real-time coefficient of variation is improved by a preset percentage (e.g. 5%), it may be determined that the traffic inbound to the plurality of servers 30 is uniformly distributed across the servers.

Thereafter, the traffic state determination module 113 may determine whether the traffic distribution between the plurality of servers 30 has been achieved at the target level based on the comparison result as the result of performing the operation S425-1. As in the previous example, the real-time coefficient of variation improvement percentage is set to 5%. In this case, when the second real-time coefficient of variation is reduced by 5% or greater relative to the first real-time coefficient of variation, the traffic state determination module 113 may determine that the traffic distribution has been achieved at the target level. On the contrary, when the second real-time coefficient of variation decreases by a value smaller than 5% or increases relative to the first real-time coefficient of variation, the traffic state determination module 113 may determine that the traffic distribution has not been achieved at the target level.

According to the present embodiment, whether the traffic distribution has been achieved at the target level may be determined based on the real-time coefficient of variation improvement ratio, the inbound traffic may be uniformly distributed across the plurality of servers 30 while minimizing the connection-broken phenomenon of the related request.

The present disclosure will be described with reference to FIG. 6.

When the traffic state determination module 113 determines that the traffic distribution has been achieved at the target level, the traffic state determination module 113 may initialize a server-specific weight related to each of the plurality of servers 30 in S426. The server-specific weight may be used to determine a quantity of the inbound traffic to be distributed to each of the plurality of servers 30 based on the quantity of the inbound traffic received by each of the servers. That is, when the traffic distribution has been achieved at the target level, this means that traffic is uniformly distributed across the plurality of servers 30. Thus, the traffic state determination module 113 initializes the server-specific weight so that the traffic is distributed under a preset load balancing algorithm (i.e., path selection algorithm).

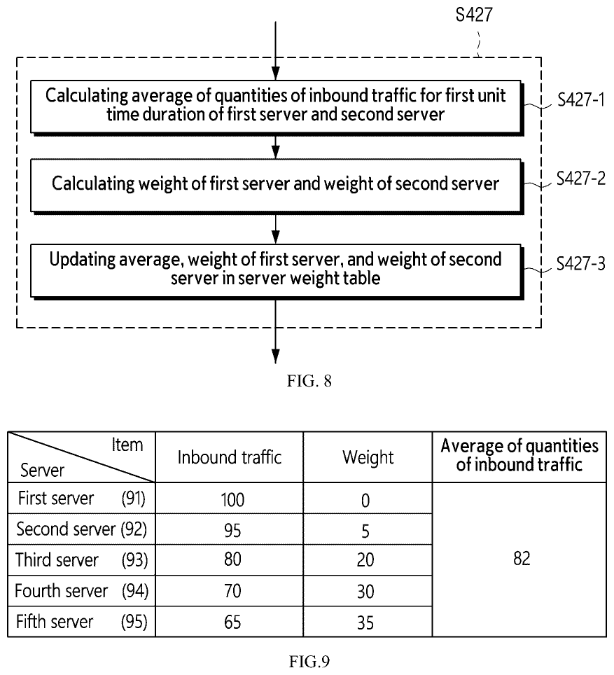

On the contrary, when the traffic state determination module 113 determines that the traffic distribution has not been achieved at the target level, the traffic state determination module 113 may update the server-specific weight of each of the plurality of servers 30 in S427. Hereinafter, a method for updating the server-specific weight according to an embodiment of the present disclosure will be as described with reference to FIG. 8. FIG. 8 is a detailed flowchart for illustrating some operations of the traffic distribution method as described with reference to FIG. 6.

Referring to FIG. 8, the traffic state determination module 113 may calculate an average of the quantities of the inbound traffic for the first unit time duration of a first server and a second server constituting the plurality of servers 30 in S427-1. In this case, it is assumed that a quantity of the inbound traffic for the first unit time duration of the first server is greater than a quantity of the inbound traffic for the first unit time duration of the second server.

Thereafter, the traffic state determination module 113 may calculate a weight of the first server and a weight of the second server using the quantity of the inbound traffic for the first unit time duration of the first server as a reference value in S427-1.

Thereafter, the traffic state determination module 113 may update the average calculated in the operation S427-1, and the weight of the first server and the weight of the second server calculated in the operation S427-2 in a server weight table in S427-3. The server weight table may be a table including the average listed above, the weight of the first server, and the weight of the second server. The managing system 110 may transmit the server weight table to the BPF map 120, and the BPF map 120 may store the server weight table therein and transmit the table to the load balancer 130. The load balancer 130 may distribute the traffic across the plurality of servers 30 based on the information on the server-specific weight of each of the servers included in the server weight table. That is, the server weight table may be updated by the managing system 110, and the load balancer 130 may perform traffic distribution across the plurality of servers 30 with reference to the server weight table.

Hereinafter, a method for updating the server weight table will be as described with reference to FIG. 9. FIG. 9 is a diagram for illustrating a process of determining whether a traffic distribution imbalance state occurs, which may be performed in some embodiments of the present disclosure.

Referring to FIG. 9, it is assumed that the plurality of servers 30 are composed of first to fifth servers 91, 92, 93, 94, and 95. For the first unit time duration, the inbound traffic of the first server 91 is 100, the inbound traffic of the second server 92 is 95, the inbound traffic of the third server 93 is 80, the inbound traffic of the fourth server 94 is 70, and the inbound traffic of the fifth server 95 is 65.

In the above case, the average of the quantities of the inbound traffic of the first to fifth servers 91, 92, 93, 94, and 95 for the first unit time duration is 82.

In this case, among the first to fifth servers 91, 92, 93, 94, and 95, the first server 91 has the largest quantity of the inbound traffic for the first unit time duration. Accordingly, the traffic state determination module 113 may calculate the server-specific weight of each of the first to fifth servers 91, 92, 93, 94, and 95 based on the quantity of the inbound traffic for the first unit time duration of the first server 91.

A reference value of the server-specific weight may be set to 0. However, embodiments of the present disclosure are not limited thereto, and the reference value of the server-specific weight may be set to vary based on various criteria.

When the reference value is set to 0, the weight of the first server 91 becomes 0. The weight of the second server 92 is 5 because the quantity of the inbound traffic for the first unit time duration of the second server 92 is smaller than the quantity of the inbound traffic for the first unit time duration of the first server 91 by 5. When the server-specific weight is calculated in the same way, the weight of the third server 93 becomes 20, the weight of the fourth server 94 becomes 30, and the weight of the fifth server 95 becomes 35.

The traffic state determination module 113 may update the average of the quantities of the inbound traffic calculated as described above and the inbound traffic received by each of the plurality of servers 30 and the server-specific weight thereof in the server weight table.

According to the present embodiment, the managing system 110 may calculate the server-specific weight, etc., and transmit the calculation result to the load balancer 130. Thus, the managing system 110 may perform a complex calculation requiring a greater amount of resources, while the load balancer 130 may perform only the traffic distribution across the plurality of servers based on the calculation result. Therefore, according to the present embodiment, since the roles of the managing system 110 and the load balancer 130 are separated from each other, there is an advantage in that the load balancing is achieved at runtime while efficiently using the resources according to the characteristics of the environment to which each system belongs.

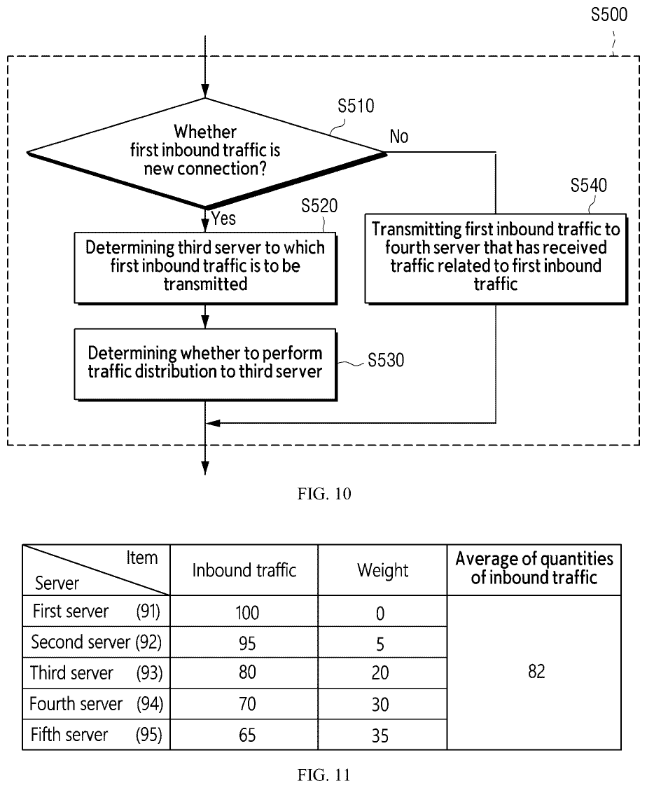

Hereinafter, a method for performing traffic distribution across the plurality of servers according to an embodiment of the disclosure will be as described with reference to FIG. 10. FIG. 10 is a detailed flowchart for illustrating some operations of the traffic distribution method as described with reference to FIG. 3.

Referring to FIG. 10, the server determination module 132 mounted in the load balancer 130 may determine whether first inbound traffic received by the traffic distribution system 100 is a new connection with reference to connection information about the first inbound traffic received by the traffic distribution system 100 in S510.

The server determination module 132 may determine whether the first inbound traffic is traffic having previously registered connection information or traffic having new connection information with reference to connection information (5-tuple) of a connection tracking table stored in the data management module 121 of the BPF map 120. The connection tracking table may track a connection occurring in a network and maintain a state thereof. The connection tracking table may store therein information on each connection, and may include the connection information (5-tuple) such as IP addresses of a transmitter and a receiver, a port number, a connection state, etc.

When the server determination module 132 determines that the first inbound traffic is not the new connection, that is, when the first inbound traffic is the traffic having the previously registered connection information, the server determination module 132 may transmit the first inbound traffic to the fourth server that has received the traffic related to the first inbound traffic based on destination information included in the connection information of the first inbound traffic in S540. Through the operation S540, when the request of the client 20 is a related request, the related request may be processed by a specific server, thereby preventing a connection-broken phenomenon of the related request and achieving a faster request processing speed. For example, since a login request onto a website of a client and a request for putting an article in a shopping cart in the corresponding website are related requests, it is preferable to allow one server to process the request to prevent the connection-broken phenomenon.

On the contrary, when the server determination module 132 determines that the first inbound traffic is a new connection, the server determination module 132 may determine a third server to which the first inbound traffic received by the traffic distribution system 100 is to be transmitted, using a predetermined path selection algorithm in S520. The predetermined path selection algorithm may be, for example, the Maglev hashing algorithm as described above as the load balancing algorithm. However, embodiments of the present disclosure are not limited thereto, and a round robin scheme and a consistent hashing scheme may also be employed as the path selection algorithm.

Thereafter, the server determination module 132 may determine whether to perform traffic distribution to the third server with reference to the server weight table in S530. The server weight table may include information on a server-specific weight of each of the plurality of servers 30 and the average of the quantities of the inbound traffic for the first unit time duration of the plurality of servers 30. The load balancer 130 may receive the server weight table updated by the managing system 110 from the BPF map 120 and may refer to the received server weight table.

When the third server determined in the operation S520 receives a quantity of the inbound traffic exceeding the average of the quantities of the inbound traffic for the first unit time duration of the plurality of servers 30, the server determination module 132 may perform traffic distribution to the fifth server having the highest weight based on the weight of each of the plurality of servers 30.

On the contrary, when the third server determined in operation S520 receives a quantity of the inbound traffic equal to or smaller than the average of the quantities of the inbound traffic for the first unit time duration of the plurality of servers 30, the server determination module 132 may transmit the first inbound traffic to the third server.

Hereinafter, a method for determining whether to perform traffic distribution to the third server according to some embodiments of the present disclosure will be as described with reference to FIG. 11. FIG. 11 is a diagram for illustrating a process of performing traffic distribution across the plurality of servers, which may be performed in some embodiments of the present disclosure.

Referring to FIG. 11, as in the example as described with reference to FIG. 9, it is assumed that the plurality of servers are composed of the first to fifth servers 91, 92, 93, 94, and 95. For the first unit time duration, the inbound traffic of the first server 91 is 100, the inbound traffic of the second server 92 is 95, the inbound traffic of the third server 93 is 80, the inbound traffic of the fourth server 94 is 70, and the inbound traffic of the fifth server 95 is 65.

In the above case, the average of the quantities of the inbound traffic of the first to fifth servers 91, 92, 93, 94, and 95 for the first unit time duration is 82.

In the above case, it is assumed that the weight of the first server 91 is 0. The weight of the second server 92 is 5 because the quantity of the inbound traffic for the first unit time duration of the second server 92 is smaller than the quantity of the inbound traffic for the first unit time duration of the first server 91 by 5. When the server-specific weight is calculated in the same way, the weight of the third server 93 becomes 20, the weight of the fourth server 94 becomes 30, and the weight of the fifth server 95 becomes 35.

Among the plurality of servers 91 to 95, the server that has received the quantity of the inbound traffic exceeding the average of the quantities of the inbound traffic received by the plurality of servers 91 to 95 for the first unit time duration is the first server 91 and the second server 92. On the contrary, among the plurality of servers 91 to 95, the server that has received the quantity of the inbound traffic smaller than or equal to the average of the quantities of the inbound traffic received by the plurality of servers 91 to 95 for the first unit time duration are the third server 93, the fourth server 94, and the fifth server 95.

The server determination module 132 may determine the server having the highest server-specific weight as a server that receives the traffic from other servers.

That is, in the above example, the server determination module 132 may distribute the inbound traffic received by the first server 91 and the second server 92 to the fifth server 95 having the highest weight.

The quantity of the inbound traffic to be distributed from the first server 91 and the second server 92 to the fifth server 95 is 31 (18+13).

According to the present embodiment, the traffic distribution system 100 may efficiently rebalance the traffic during the runtime based on a result of determining whether the traffic is uniformly distributed across the plurality of servers 30 even at the runtime.

In addition, according to the present embodiment, since the roles of the managing system 110 and the load balancer 130 are separated from each other, the resources are efficiently used according to the characteristics of the environment to which each system belongs, while the load balancing is achieved at the runtime.

Further, in an embodiment, the data management module 131 mounted in the load balancer 130 may store, in the connection information of the first inbound traffic, information about a server to which the first inbound traffic is to be transmitted, as a result of the operation of determining whether to perform traffic distribution to the third server performed by the server determination module 132.

According to the present embodiment, whether the inbound traffic received by the traffic distribution system 100 after the first inbound traffic is a request related to the first inbound traffic may be determined. Thus, the load balancing may be performed so that the same server may process the related request. Accordingly, according to the present embodiment, the connection-broken phenomenon of the related request may be prevented such that a faster request processing speed may be achieved.

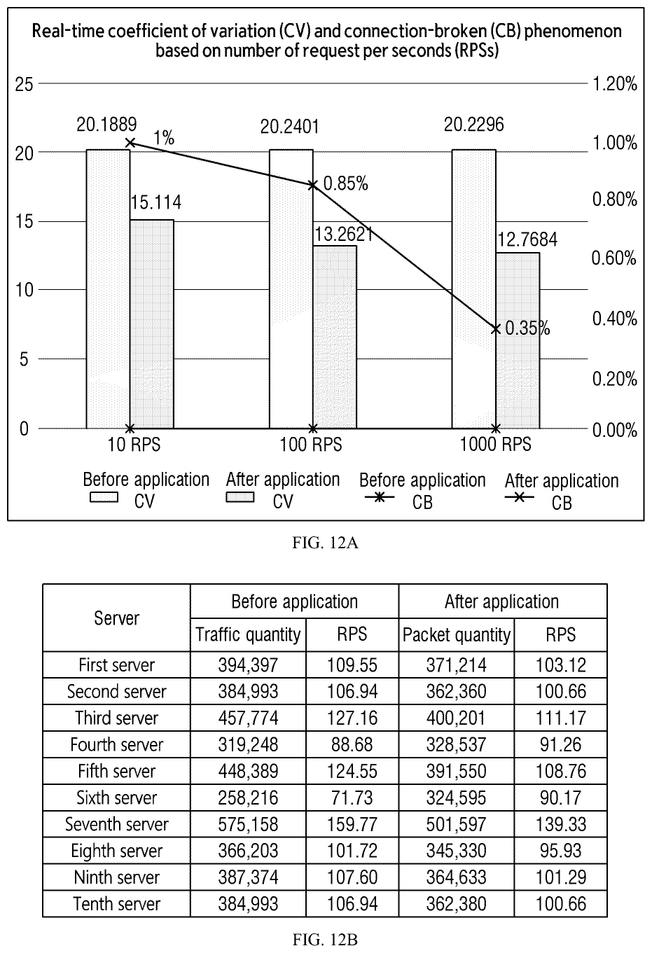

Hereinafter, the performance result performed by some embodiments of the present disclosure will be as described with reference to FIGS. 12A and 12B. FIGS. 12A and 12B are diagrams illustrating performance results performed by some embodiments of the present disclosure. The performance result is a result performed in a situation where there is one client 20, one load balancer 130, and ten servers 30.

Referring to FIG. 12A, the real-time coefficient of variation (CV) and the number of occurrences of the connection-broken (CB) phenomenon based on the number of request per seconds (RPSs) are illustrated.

When the traffic distribution system 100 receives 10 RPSs, the real-time coefficient of variation before the traffic distribution method according to the present disclosure is applied is 20.1889, whereas the real-time coefficient of variation is reduced to 15.114 after the traffic distribution method according to the present disclosure is applied. When the traffic distribution system 100 receives 100 RPSs, the real-time coefficient of variation before the traffic distribution method according to the present disclosure is applied is 20.2401, whereas the real-time coefficient of variation is reduced to 13.2621 after the traffic distribution method according to the present disclosure is applied. When the traffic distribution system 100 receives 1000 RPSs, the real-time coefficient of variation before the traffic distribution method according to the present disclosure is applied is 20.2296, whereas the real-time coefficient of variation is reduced to 12.7684 after the traffic distribution method according to the present disclosure is applied.

When the traffic distribution system 100 receives 10 RPSs, the connection-broken phenomenon before the traffic distribution method according to the present disclosure is applied is 0%, whereas the connection-broken phenomenon after the traffic distribution method according to the present disclosure is applied is 1%. When the traffic distribution system 100 receives 100 RPS, the connection-broken phenomenon before the traffic distribution method according to the present disclosure is applied is 0%, whereas the connection-broken phenomenon after the traffic distribution method according to the present disclosure is applied is 0.85%. When the traffic distribution system 100 receives 1000 RPS, the connection-broken phenomenon before the traffic distribution method according to the present disclosure is applied is 0%, whereas the connection-broken phenomenon after the traffic distribution method according to the present disclosure is applied is 0.35%.

Referring to FIG. 12A, it may be identified that as the number of requests per second (RPS) received by the traffic distribution system 100 from the client 20 increases, the reduction in the real-time coefficient of variation increases after the traffic distribution method according to the present disclosure is applied, rather than before the traffic distribution method according to the present disclosure is applied. That is, it may be identified that the traffic distribution method according to the present disclosure may more effectively and uniformly distribute the traffic as the quantity of the inbound traffic introduced into the traffic distribution system 100 increases.

In addition, it may be identified that when the traffic distribution method according to the present disclosure is applied, the reduction in the occurrence of the connection-broken phenomenon increases as the number of requests per second (RPS) received by the traffic distribution system 100 from the client 20 increases. That is, it may be identified that using the traffic distribution method according to the present disclosure, the traffic may be more effectively and uniformly distributed, and the connection-broken phenomenon of the related requests may be minimized as the quantity of the inbound traffic introduced into the traffic distribution system 100 increases.

Referring to FIG. 12B, a table showing the number of the inbound traffic received by each of the servers when the traffic distribution system 100 receives 1000 RPSs in the above-described performing environment is illustrated.

Before the traffic distribution method according to the present disclosure is applied, the server that has received the greatest quantity of the inbound traffic from the traffic distribution system 100 is the seventh server which receives a total of 159.77 RPSs. Before the traffic distribution method according to the present disclosure is applied, the server that has received the smallest quantity of the inbound traffic from the traffic distribution system 100 is the sixth server which receives a total of 71.73 RPSs. In this case, the seventh server further receives and processes the quantity of the inbound traffic greater by 223% relative to that of the sixth server.

On the contrary, after the traffic distribution method according to the present disclosure is applied, the server that has received the greatest quantity of the inbound traffic from the traffic distribution system 100 is the seventh server which receives a total of 139.33 RPSs. After the traffic distribution method according to the present disclosure is applied, the server that has received the smallest quantity of the inbound traffic from the traffic distribution system 100 is the sixth server which receives a total of 90.17 RPSs. In this case, the seventh server further receives and processes the quantity of the inbound traffic greater by 155% relative to that of the sixth server.

As shown in FIG. 12B, it may be identified that in an embodiment to which the traffic distribution method according to the present disclosure is applied, the inbound traffic is more uniformly distributed across the plurality of servers 30 than in the case to which the traffic distribution method according to the present disclosure is not applied.

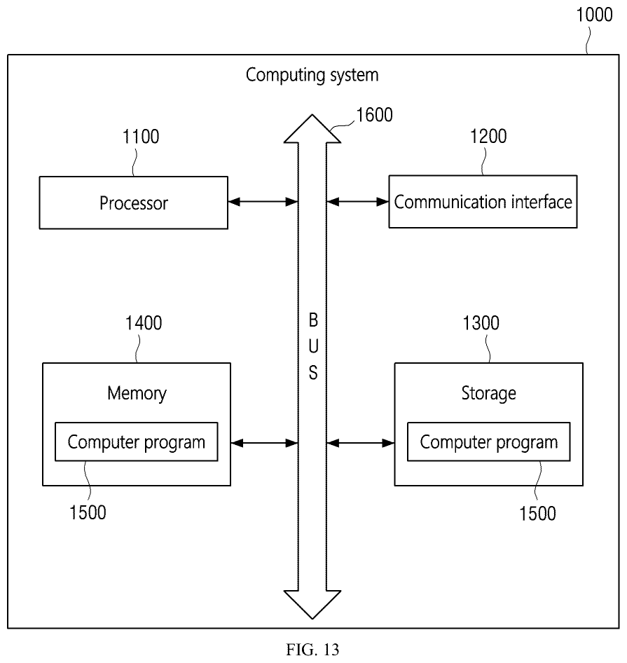

FIG. 13 is a hardware configuration diagram of a computing system according to some embodiments of the present disclosure.

A computing system 1000 of FIG. 14 may include one or more processors 1100, a system bus 1600, a communication interface 1200, a memory 1400 for loading thereon a computer program 1500 executed by the processor 1100, and storage 1300 for storing therein the computer program 1500.

The computing system 1000 of FIG. 13 may, for example, present a hardware structure of at least one computing system constituting the traffic distribution system 100 for load-balancing the inbound traffic introduced into the plurality of servers as described with reference to FIG. 2.

The processor 1100 controls overall operations of each of the components of the computing system 1000. The processor 1100 may perform an operation on at least one application or program for executing a method/operation according to various embodiments of the present disclosure. The memory 1400 stores therein various data, commands, and/or information. The memory 1400 may load thereon one or more computer programs 1500 from the storage 1300 to execute methods/operations according to various embodiments of the present disclosure. The storage 1300 may non-temporarily store therein one or more computer programs 1500.

The computer program 1500 may include one or more instructions for executing methods/operations according to various embodiments of the present disclosure. When the computer program 1500 is loaded into the memory 1400, the processor 1100 may perform methods/operations according to various embodiments of the present disclosure by executing the one or more instructions.

In an embodiment, the computer program 1500 may include instructions for acquiring traffic data on a quantity of inbound traffic to each of the plurality of servers; calculating a coefficient of variation of the traffic data for a first unit time duration, an interval average of the coefficients of variation for a second unit time duration, and an interval standard deviation of the coefficients of variation for the second unit time duration, wherein the second unit time duration may include a plurality of first unit time durations; performing a real-time calculation on the coefficient of variation of the traffic data for the first unit time duration to calculate a real-time coefficient of variation; determining whether a traffic distribution imbalance state across the plurality of servers occurs, based on a result of comparing the real-time coefficient of variation with the interval average and the interval standard deviation; and performing traffic distribution across the plurality of servers, based on the determination result of whether the traffic distribution imbalance state across the plurality of servers occurs.

Various embodiments of the present disclosure and the effects according to the embodiments have been described above with reference to FIGS. 1 to 13. However, the effects according to the technical idea of the present disclosure are not limited to the above-mentioned effects, and other effects not mentioned may be clearly understood by a person skilled in the art from the above descriptions.

Further, it has been described that in the above embodiments, the plurality of components are combined into one or operate in combination with each other. However, the technical idea of the present disclosure is not necessarily limited to such embodiments. That is, within the scope of the technical idea of the present disclosure, all of the components may be selectively combined into at least one.

The technical idea of the present disclosure described above may be implemented as computer-readable code on a computer-readable medium. A computer program recorded in a computer-readable recording medium may be transmitted to another computing device through a network such as the Internet and may be installed in another computing device, and thus may be used in another computing device.

Although embodiments of the present disclosure have been described above with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. A traffic distribution method for load-balancing inbound traffic incoming into a plurality of servers, the traffic distribution method being performed by a computing system, wherein the traffic distribution method comprises:
acquiring traffic data on a quantity of inbound traffic to each of the plurality of servers;
calculating one or more coefficients of variation of the traffic data for a first unit time duration, an interval average of coefficients of variation for a second unit time duration, and an interval standard deviation of the coefficients of variation for the second unit time duration, wherein the second unit time duration includes the plurality of first unit time durations;
performing a real-time calculation on the coefficient of variation of the traffic data for the first unit time duration to calculate a real-time coefficient of variation;
determining whether a traffic distribution imbalance state across the plurality of servers occurs, based on a result of comparing the real-time coefficient of variation with the interval average and the interval standard deviation; and
performing traffic distribution across the plurality of servers, based on the determination result of whether the traffic distribution imbalance state across the plurality of servers occurs.

2. The traffic distribution method of claim 1, wherein the coefficient of variation for the first unit time duration is a value obtained by dividing a standard deviation of the inbound traffic incoming into the plurality of servers for the first unit time duration by an average of the inbound traffic incoming into the plurality of servers for the first unit time duration,
wherein the determining of whether the traffic distribution imbalance state across the plurality of servers occurs includes:
calculating a first threshold based on a following Equation 1; and
determining whether the real-time coefficient of variation exceeds the first threshold:
First threshold=(the interval average)+{n*(the interval standard deviation)}, where n is a non-negative integer. [Equation 1]

3. The traffic distribution method of claim 2, wherein the determining of whether the real-time coefficient of variation exceeds the first threshold includes:
acquiring first data on a quantity of traffic processed by the computing system for the first unit time duration;
determining whether the first data exceeds a second threshold; and
only upon determination that the first data exceeds the second threshold, determining whether the real-time coefficient of variation exceeds the first threshold,
wherein the second threshold is a value of a minimum quantity of traffic for performing traffic distribution across the plurality of servers.

4. The traffic distribution method of claim 2, wherein the determining of whether the real-time coefficient of variation exceeds the first threshold includes:
upon determination that the real-time coefficient of variation exceeds the first threshold, determining whether the traffic distribution across the plurality of servers has been achieved at a target level;
upon determination that the traffic distribution has been achieved at the target level, initializing a server-specific weight of each of the plurality of servers; and
upon determination that the traffic distribution has not been achieved at the target level, updating the server-specific weight of each of the plurality of servers.

5. The traffic distribution method of claim 4, wherein the determining of whether the traffic distribution across the plurality of servers has been achieved at the target level includes:
comparing a first real-time coefficient of variation at a first time point with a second real-time coefficient of variation at a second time point; and
determining whether the traffic distribution has been achieved at the target level, based on a result of the comparison,
wherein the first time point precedes the second time point by the first unit time duration.

6. The traffic distribution method of claim 4, wherein the updating of the server-specific weight includes:
calculating an average of quantities of the inbound traffic for the first unit time duration of a first server and a second server constituting the plurality of servers, wherein the quantity of the inbound traffic for the first unit time duration of the first server is greater than the quantity of the inbound traffic for the first unit time duration of the second server;
calculating a weight of the first server and a weight of the second server using the quantity of the inbound traffic for the first unit time duration of the first server as a reference value; and
updating the average, the weight of the first server, and the weight of the second server in a server weight table.

7. The traffic distribution method of claim 1, wherein the performing of the traffic distribution across the plurality of servers includes:
determining a third server to which first inbound traffic received by the computing system is to be transmitted, using a predetermined path selection algorithm; and
determining whether to perform traffic distribution to the third server, with reference to a server weight table,
wherein the server weight table includes information about a server-specific weight of each of the plurality of servers and an average of quantities of the inbound traffic for the first unit time duration of the plurality of servers.

8. The traffic distribution method of claim 7, further comprising:
determining whether the first inbound traffic is a new connection with reference to connection information of the first inbound traffic; and
upon determination the first inbound traffic is not the new connection, transmitting the first inbound traffic to a fourth server that has received traffic related to the first inbound traffic, using destination information included in the connection information of the first inbound traffic; or
upon determination that the first inbound traffic is the new connection, determining the third server and determining whether to perform traffic distribution to the third server.

9. The traffic distribution method of claim 7, wherein the determining of whether to perform the traffic distribution to the third server includes:
in response to that the determined third server receives a quantity of the inbound traffic exceeding the average, performing traffic distribution to a fifth server having a highest weight based on the server-specific weight of each of the plurality of servers;
in response to that the determined third server receives a quantity of the inbound traffic smaller than or equal to the average, transmitting the first inbound traffic to the third server; and
storing information about a server to which the first inbound traffic is to be transmitted in the connection information of the first inbound traffic, wherein the information about the server includes a result of performing the determining of whether to perform the traffic distribution to the third server.

10. A traffic distribution computing system for load-balancing inbound traffic across a plurality of servers, the traffic distribution computing system comprising:
a communication interface;
a memory into which a computer program is loaded; and
one or more processors configured to execute the computer program,
wherein the computer program includes instructions for:
acquiring traffic data on a quantity of inbound traffic to each of the plurality of servers;
calculating a coefficient of variation of the traffic data for a first unit time duration, an interval average of coefficients of variation for a second unit time duration, and an interval standard deviation of the coefficients of variation for the second unit time duration, wherein the second unit time duration includes a plurality of first unit time durations;
performing a real-time calculation on the coefficient of variation of the traffic data for the first unit time duration to calculate a real-time coefficient of variation;
determining whether a traffic distribution imbalance state across the plurality of servers occurs, based on a result of comparing the real-time coefficient of variation with the interval average and the interval standard deviation; and
performing traffic distribution across the plurality of servers, based on the determination result of whether the traffic distribution imbalance state across the plurality of servers occurs.

11. The traffic distribution computing system of claim 10, wherein the determining of whether the traffic distribution imbalance state across the plurality of servers occurs includes:
calculating a first threshold based on a following Equation 1; and
determining whether the real-time coefficient of variation exceeds the first threshold:
First threshold=(the interval average)+{n*(the interval standard deviation)}, where n is a non-negative integer. [Equation 1]

12. The traffic distribution computing system of claim 11, wherein the determining of whether the real-time coefficient of variation exceeds the first threshold includes:
acquiring first data on a quantity of traffic processed by the traffic distribution computing system for the first unit time duration;
determining whether the first data exceeds a second threshold; and
only upon determination that the first data exceeds the second threshold, determining whether the real-time coefficient of variation exceeds the first threshold,
wherein the second threshold is a value of a minimum quantity of traffic for performing traffic distribution across the plurality of servers.

13. The traffic distribution computing system of claim 11, wherein the determining of whether the real-time coefficient of variation exceeds the first threshold includes:
upon determination that the real-time coefficient of variation exceeds the first threshold, determining whether the traffic distribution across the plurality of servers has been achieved at a target level;
upon determination that the traffic distribution has been achieved at the target level, initializing a server-specific weight of each of the plurality of servers; and
upon determination that the traffic distribution has not been achieved at the target level, updating the server-specific weight of each of the plurality of servers.

14. The traffic distribution computing system of claim 13, wherein the determining of whether the traffic distribution across the plurality of servers has been achieved at the target level includes:
comparing a first real-time coefficient of variation at a first time point with a second real-time coefficient of variation at a second time point; and
determining whether the traffic distribution has been achieved at the target level, based on a result of the comparison,
wherein the first time point precedes the second time point by the first unit time duration.

15. The traffic distribution computing system of claim 13, wherein the updating of the server-specific weight includes:
calculating an average of quantities of the inbound traffic for the first unit time duration of a first server and a second server constituting the plurality of servers, wherein the quantity of the inbound traffic for the first unit time duration of the first server is greater than the quantity of the inbound traffic for the first unit time duration of the second server;
calculating a weight of the first server and a weight of the second server using the quantity of the inbound traffic for the first unit time duration of the first server as a reference value; and
updating the average, the weight of the first server, and the weight of the second server in a server weight table.

16. The traffic distribution computing system of claim 10, wherein the performing of the traffic distribution across the plurality of servers includes:
determining a third server to which first inbound traffic received by the traffic distribution computing system is to be transmitted, using a predetermined path selection algorithm; and
determining whether to perform traffic distribution to the third server, with reference to a server weight table,
wherein the server weight table includes information about a server-specific weight of each of the plurality of servers and an average of quantities of the inbound traffic for the first unit time duration of the plurality of servers.

17. The traffic distribution computing system of claim 16, wherein the computer program further includes instructions for:
determining whether the first inbound traffic is a new connection with reference to connection information of the first inbound traffic; and
upon determination the first inbound traffic is not the new connection, transmitting the first inbound traffic to a fourth server that has received traffic related to the first inbound traffic, using destination information included in the connection information of the first inbound traffic; or
upon determination that the first inbound traffic is the new connection, determining the third server and determining whether to perform traffic distribution to the third server.

18. The traffic distribution computing system of claim 16, wherein the determining of whether to perform the traffic distribution to the third server includes:
in response to that the determined third server receives a quantity of the inbound traffic exceeding the average, performing traffic distribution to a fifth server having a highest weight based on the server-specific weight of each of the plurality of servers;
in response to that the determined third server receives a quantity of the inbound traffic smaller than or equal to the average, transmitting the first inbound traffic to the third server; and
storing information about a server to which the first inbound traffic is to be transmitted in the connection information of the first inbound traffic, wherein the information about the server includes a result of performing the determining of whether to perform the traffic distribution to the third server.
